(19) United States
(12) Patent Application Publication
(10) Pub. No.: US 2020/0232898 A1
(43) Pub. Date: Jul. 23, 2020

(54) METHOD FOR CALCULATING SERVICE LIFE OF FILTER GAUZE

(71) Applicant: Aether Services, Taiwan, Ltd., Hsinchu City (TW)

(72) Inventors: Jui-Pin Wu, HSINCHU CITY (TW); Chun-Yuan Lee, HSINCHU CITY (TW); Chen-Chia Tsai, HSINCHU CITY (TW); Ying-Peng Wu, HSINCHU CITY (TW)

(21) Appl. No.: 16/838,508

(22) Filed: Apr. 2, 2020

Related U.S. Application Data
(63) Continuation-in-part of application No. 15/833,278, filed on Dec. 6, 2017.
(60) Provisional application No. 62/432,774, filed on Dec. 12, 2016.

(51) Int. Cl. G01N 15/08

(52) U.S. Cl. CPC G01N 15/0806; G01N 2015/084

(57) ABSTRACT

A method for calculating a service life of a filter gauze is applicable to an air cleaner. The method includes: according to data of a rotational speed of a fan and an airborne particle concentration, calculating an outlet air velocity, and a blocking ratio of the filter gauze; and further calculating a remaining service life of the filter gauze. In this way, a user can be more accurately informed of the remaining service life of the filter gauze, and instructed to change the filter gauze at the most appropriate time.

### CROSS-REFERENCE TO RELATED APPLICATION

This application claims the benefit as a continuation-in-part of U.S. patent application Ser. No. 15/833,278, filed on Dec. 6, 2017, which is hereby incorporated by reference for all purposes as if fully set forth herein.

### BACKGROUND

### Technical Field

The present disclosure relates to a method for calculating a service life of a filter gauze, and in particular, to a method for calculating a service life of a filter gauze applicable to an air cleaner. In this way, a user can be more accurately informed of a remaining service life of the filter gauze of the air cleaner, and instructed to change the filter gauze of the air cleaner at the most appropriate time.

### Related Art

Currently, for most air cleaners on the market, a remaining service life of a filter gauze is calculated based on a fixed timer, that is, the remaining service life of the filter gauze is calculated only according to a running time, regardless of air quality and a rotational speed of a fan. This method calculating the remaining service life of the filter gauze is simple, but the filter gauze is usually changed too early or too late.

US Patent Publication No. US 2012/0318135A1 discloses methods and systems for monitoring the condition of a new air filter installed in an HVAC system are disclosed.” In one example, an input that indicates a new air filter has been installed may be accepted, and in response, the HVAC system may be automatically operated in an air filter verifying mode, in which the fan of the HVAC system is activated to drive air through the new air filter. While in the air filter verifying mode, a measure related to an amount of flow restriction presented by the new air filter may be received. A status of the new air filter may be determined based, at least in part, on the received measure related to the amount of flow restriction presented by the air filter of the HVAC system. Once the status of the new air filter is determined, an indication may be displayed on a display, which may communicate the determined status of the new air filter to a user.

US Patent Publication No. US 2014/0144111A1 discloses filter cartridge arrangements, features thereof and assembly for use therewith, are provided. Selected filter cartridge features disclosed are particularly well adapted for use with a safety or secondary filter cartridge, usable with media thereof projecting into an open interior of a main filter cartridge, in use. An example filter cartridge is described, with a non-pleated end and a pleated end, although variations are also described. Advantageous main cartridges are also described. Methods of assembly and systems for use are described.

However, both of the above-mentioned patent documents (US 2012/0318135A1 and US 2014/0144111A1) fail to disclose a method for calculating a service life of a filter gauze, the method including: according to data of a rotational speed of a fan and an airborne particle concentration, calculating an outlet air velocity, and a blocking ratio of the filter gauze; and further calculating a remaining service life of the filter gauze.

### SUMMARY

An objective of the present disclosure is mainly to provide a method for calculating a service life of a filter gauze applicable to an air cleaner. A remaining service life of the filter gauze of the air cleaner is calculated by using an airborne particle concentration sensed by a sensor and a rotational speed of a fan of the air cleaner, and a user is instructed to change the filter gauze of the air cleaner at the most appropriate time.

The method for calculating a service life of a filter gauze in the present disclosure is applicable to an air cleaner, the method including: according to data of a rotational speed of a fan and an airborne particle concentration, calculating an outlet air velocity and a blocking ratio of the filter gauze; and further calculating a remaining service life of the filter gauze.

To make the foregoing and other objectives, features, and advantages of the present disclosure more obvious, the following provides description in detail as follows with reference to the accompanying drawings.

### BRIEF DESCRIPTION OF THE DRAWINGS

FIG. 1 is a schematic sectional view a structure of an air cleaner according to an embodiment of the present disclosure.

FIG. 2 is a flowchart of a method for calculating a service life of a filter gauze according to an embodiment of the present disclosure.

### DETAILED DESCRIPTION

To further understand the objective, structural features and functions of the present disclosure, descriptions are provided in detail with reference to the related embodiment and figure as follows:

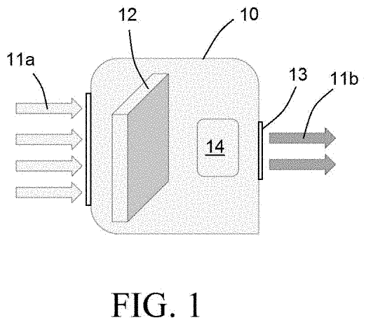

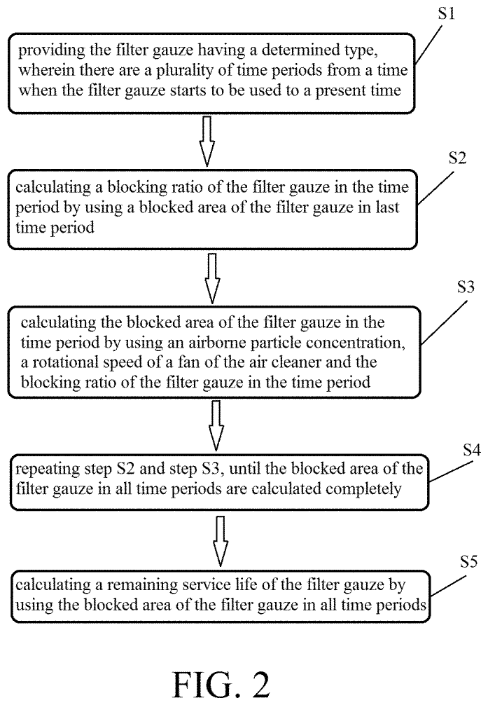

FIG. 1 is a schematic sectional view a structure of an air cleaner 10 according to an embodiment of the present disclosure, showing that a filter gauze 12 is applicable to an air cleaner 10. FIG. 2 is a flowchart of a method for calculating a service life of a filter gauze according to an embodiment of the present disclosure. The method for calculating a service life of a filter gauze 12 includes of the following: step S1 of providing the filter gauze 12 having a determined type, wherein there are a plurality of time periods from a time when the filter gauze 12 starts to be used to a present time; step S2 of calculating a blocking ratio of the filter gauze 12 in the time period by using a blocked area of the filter gauze 12 in last time period; step S3 of calculating the blocked area of the filter gauze 12 in the time period by using an airborne particle concentration, a rotational speed of a fan 14 of the air cleaner 10 and the blocking ratio of the filter gauze 12 in the time period; step S4 of repeating step S2 and step S3, until the blocked area of the filter gauze 12 in all time periods are calculated completely; and step S5 of calculating a remaining service life of the filter gauze 12 by using the blocked area of the filter gauze 12 in all time periods.

When air (i.e., unfiltered air 11a) including airborne particles passes through a filter gauze 12, most of the airborne particles are netted or absorbed by the filter gauze 12. For a general E11 filter gauze, more than 95% of the particles of bigger than 0.3 mircometers are netted, and only less than 5% of the particles pass through the filter gauze 12 when the filtered air 11b goes away.

After the filter gauze nets the airborne particles, pores on a cleaner material of the filter gauze for particles to pass through become fewer, and fewer particles pass through the filter gauze. However, an outlet air velocity v of a air cleaner becomes smaller, and consequently total amount of air that can be filtered per hour (CADR, clean air delivery rate) by the filter reduces. Once an actual value of the CADR of the filter gauze, that is, CADR-rt, reduces to below a remaining ratio p (0<p<1, p is preset to be 0.5 in this embodiment) of an original value of the CADR of the filter gauze, that is, CADR-max, it is suggested that a user should change the filter gauze. In other embodiment, of course, the remaining ratio p can be preset to be another value between 0 and 1, but the remaining ratio p can be preset to be 0.5 according to general custom. As mentioned above, CADR-rt=p×CADR-max.

The foregoing outlet air velocity v is in positive correlation with a value of the CADR. The foregoing outlet air velocity v is in positive correlation with a rotational speed r of a fan of an air cleaner, and is in negative correlation with a blocking degree of the filter gauze. The following formulas represent the relationship between the outlet air velocity v, the rotational speed r of the fan, and the blocking ratio b of the filter gauze:

v(i)=k1×r(i)×[1−b(i)] —formula 1

wherein: r(i) is the rotational speed of the fan at a time period of i; b(i) is the blocking ratio of the filter gauze at the time period of i, where 0≤b(i)≤1; and k1 is a ratio of the outlet air velocity to the rotational speed of the fan, and is assumed to be a constant.

When the airborne particles pass through the filter gauze, the airborne particles are netted by the filter gauze. If a airborne particle concentration at the time period of i is c(i), the outlet air velocity of the air cleaner is v(i), a continuous operating time in this state is t(i), and a blocked area of the filter gauze is:

a(i)=k2×c(i)×v(i)×t(i) —formula 2,

wherein k2 is a transform coefficient and is assumed to be a constant.

The following formula can be obtained by substituting formula 2 with formula 1:

$$\begin{matrix}a ( i ) = k 1 \times k 2 \times c ( i ) \times r ( i ) \times [ 1 - b ( i ) \times t ( i ) \\ = ka \times c ( i ) \times r ( i ) \times [ 1 - b ( i ) ] \times t ( i ) ,\end{matrix} \qquad formula 3$$

wherein a front constant ka=k1×k2.

The blocking ratio b(i) of the filter gauze in the formula 3 can be calculated by using the blocked area a(i) of the filter gauze in last time period. When all operation time of the filter gauze are divided into n time periods (i.e., i=1, 2, . . . , n−1 and n), the airborne particle concentration c(i) and the rotational speed r(i) of the fan 14 at the time period are kept constant. Simultaneously, the operation time t(i) in each time period can be controlled to very short, so the blocking ratio b(i) can be assumed to be constant. All of the blocked areas a(i) in the time period of i (i=1 to n−1) can be accumulated to obtain a blocking ratio b(n) in the time period of i (i=n):
b(n)={a(1)+ . . . +a(n−1)}/A=Σᵢ₌₁ⁿ⁻¹a(i)/A, wherein A is a total area of the filter gauze, and b(1)=0, n≥2. In order to easily describe, this formula can be indicated as follows:

b(i)=ΣΣⱼ₌₁ⁱ⁻¹a(j)/A, and b(1)=0,i≥2 —formula 4

All of the blocked areas a(i) in the time period of i (i=1, 2, . . . , n) can be calculated completely by alternately using the formula 3 and formula 4.

The front constant ka is a parameter of the filter gauze, and can be calculated in a controllable environment of a laboratory.

When the filter gauze is new and the rotational speed r of the fan is fixed to be R (i.e., r=R), the outlet air velocity v can be measured to be V1 (i.e., v=V1) and the blocking ratio b is equal to zero (i.e., b=0). The following formula can be obtained by substituting formula 1 with b=0, and the ratio k1 can be expressed as:

k1=V1/R —formula 5.

During the use of the new filter gauze in the laboratory, airborne particles with a fixed airborne concentration c (i.e., c=C) may be placed on the new filter gauze, and the rotational speed r of the fan of the air cleaner is fixedly set to R (i.e., r=R), an operation time T required for the value of the CADR of the air cleaner to reduce from CADR-max to 0.5×CADR-max (i.e., the remaining ratio p=0.5) is measured, and simultaneously the outlet air velocity v is measured to be V2 (i.e., v=V2).

Because the rotational speed r of the fan of the air cleaner is kept constant (i.e., r=R) and the outlet air velocity v slightly reduces linearly in this process, an average air velocity Vavg is used to represent the air velocity in this process of the required operation time T as follows:

Vavg=(V1+V2)/2.

After the required operation time T, it can be obtained from formula 2 that the blocked area: a=k2×C×Vavg×T. When the remaining ratio p is equal to 0.5, the value of the CADR of the air cleaner is just equal to 0.5×CADR-max at the same time. Generally, the operation time T which is required to reduce from CADR-max to 0.5×CADR-max assumed to be a reference service life (i.e., the reference service life of the filter gauze is T). When the value of the CADR of the air cleaner to reduce from CADR-max to 0.5×CADR-max, the user can be suggested to change the filter gauze. At the same time, the blocked area a is also expressed by the blocking ratio B as follows: a=A×B.

The airborne particle concentration C and the total area A of the filter gauze can be controlled, and the required operation time T, the outlet air velocity V1 and V2 can be obtained by measurement. According to the above-mentioned formula: the blocked area a=k2×C×Vavg×T, and a=A×B, the transform coefficient k2 can be expressed as follows:

k2=2×A×B/[C×T×(V1+V2)].

In order to easily describe, the blocking ratio B is assumed to be 0.5 (e.g., referring to the remaining ratio p=0.5). Thus, the transform coefficient k2 can be expressed as follows:

k2=A/[C×T×(V1+V2)] —formula 6.

The blocking ratio B can be also assumed to be a value between 0 and 1, but the blocking ratio (B=0.5) does not affect the reference service life of the filter gauze. The assumed value of the blocking ratio B only affects that the filter gauze is blocked quickly or slowly. However, the required operation time T that the user is suggested to change the filter gauze is still the same.

The front constant ka can be obtained by using formula 5 and formula 6 as follows:

$$ka = \frac{AV 1}{CRT ( V 1 + V 2 )} . \qquad formula 7$$

For every filter gauze, the corresponding parameters: CADR-max, A, V1, V2, R, C and T can be obtained only by using the predetermined conditions in the laboratory, and the ratio k1, the transform coefficient k2 and the front constant ka can be further calculated. In the actual use, when the type of tested filter gauze is determined, a remaining service life of the filter gauze can be calculated by using the above-mentioned parameters obtained from the laboratory.

The following formula can be obtained by substituting formula 3 with formula 7:

$$a ( i ) = \frac{AV 1}{CRT ( V 1 + V 2 )} \times c ( i ) \times r ( i ) \times [ 1 - b ( i ) ] \times t ( i ) . \qquad formula 8$$

A remaining service life of the filter gauze will be calculated: It is assumed that there are n time periods (i.e., i=1 to n) from a time when a tested filter gauze starts to be used to a present time, a sum of all the time periods is the total operation time t (i.e., t=), Σᵢ₌₁ⁿt(i) and the blocked area of the filter gauze at the time period of i is a(i). After the total operation time t, the total blocked area of the filter gauze is calculated by Σᵢ₌₁ⁿa(i), and the total unblocked area of the filter gauze is further calculated by A−Σᵢ₌₁ⁿa(i). At the same time, a remaining service life tr of the filter gauze can be calculated as follows:

tr={[A−Σᵢ₌₁ⁿa(i)]/Σᵢ₌₁ⁿa(i)}×t —formula 9.

The following is an embodiment of the present disclosure.

A front constant ka should be calculated firstly. A filter gauze (i.e., the filter gauze is used in the laboratory) having a determined type is selected, the corresponding parameters: CADR-max, the total area A of the filter gauze, the outlet air velocity V1, V2, the rotational speed R, the airborne particle concentration C and the required operation time T should be obtained in the laboratory, and then the ratio k1, the transform coefficient k2 and the front constant ka can be further calculated. For example, it is assumed that the total area of the filter gauze is that A=10 m². When the airborne particle concentration C=15 μg/m3, the rotational speed R=400 rpm, the outlet air velocity V1=0.9 m/s, the outlet air velocity V2=0.45 m/s, and the remaining ratio p=0.5, it is measured that the reference service life (i.e., the required operation time) T=4000 hours, and simultaneously the blocking ratio is assumed that B=0.5.

According to the formula 7, the front constant ka can be obtained as follows:

$$Ka = \frac{AV 1}{CRT ( V 1 + V 2 )} = 10 \times 0.9 / ( 15 \times 400 \times 4000 \times ( 0.9 + 0.45 ) ) = 0.0000002778$$

Referring to step S1 shown in FIG. 2, another filter gauze (i.e., the tested filter gauze is used in the actual environment) having the same determined type (having the same front constant ka) is provided. Parameters (e.g., time period of i, time period length=the continuous operating time t(i), the airborne particle concentration c(i) and the rotational speed r(i) shown in Table 1) related to the filter gauze from the time when the filter gauze starts to be used to a present time are recorded as follows:

TABLE 1

| Time | Continous | Airborne particle | Rotational |
|---|---|---|---|
| period | operating time t(i) | concentation | speed r(i) |
| of i | (hours) | c(i) (μg/m3) | (rpm) |
| 1 | 3 | 10 | 400 |
| 2 | 0.5 | 40 | 700 |
| 3 | 0.3 | 60 | 1000 |
| 4 | 6.2 | 15 | 400 |
| 5 | 8 | 15 | 0 |
| 6 | 6 | 10 | 400 |

Subsequently referring to steps S2, S3 and S4 shown in FIG. 2, all of the blocked areas a(i) (shown in Table 2) of the filter gauze in the time period of i (i=1 to 6) can be calculated completely by alternately using formula 8 and formula 4.

TABLE 2

| | Continuous | | | | | |
|---|---|---|---|---|---|---|
| Time | operating | Airborne particle | Rotational | | | Accumulated |
| period | time t(i) | concentration e(i) | speed | b(i) | a(i) | blocked area |
| of i | (hours) | (μg/m3) | r(i) (rpm) | Formula 4 | Formula 8 | a(1) + . . . + a(i) |
| 1 | 3 | 10 | 400 | 0.000000 | 0.003333 | 0.003333 |
| 2 | 0.5 | 40 | 700 | 0.000333 | 0.003888 | 0.007221 |
| 3 | 0.3 | 60 | 1000 | 0.000722 | 0.004996 | 0.012217 |
| 4 | 6.2 | 15 | 400 | 0.001222 | 0.010321 | 0.022538 |
| 5 | 8 | 15 | 0 | 0.002254 | 0.000000 | 0.022538 |
| 6 | 6 | 10 | 400 | 0.002254 | 0.006652 | 0.029190 |

Referring to step S5 shown in FIG. 2, by using the formula 9, it is calculated that the remaining service life of the filter gauze is tr=(10−0.029190)/0.029190×24=8198 (hours).

For brevity, only the six time periods are calculated. As mentioned above, actually in the time periods, b(i) is a variable that becomes larger as a filtering time increases. For brevity herein, b(i) remains as a constant in the time periods, and this is just for facilitating calculation. In actual use, the time periods should be divided into smaller time periods, for example, each second is a time period, so that an error of an operation result is relatively small.

In comparison, if calculation is performed by using a conventional countdown method, the remaining service life tr′ of the filter gauze is estimated as:

tr′=4000−running time=4000−24=3976 (hours).

In the conventional countdown method, a remaining running time before the filter gauze needs to be changed is informed, regardless of air quality (e.g., airborne particle concentration) and a rotational speed of a fan. According to the method provided in this patent, a user can be more accurately informed of a remaining service life of a filter gauze, and instructed to change the filter gauze at a most appropriate time.

In conclusion, the foregoing descriptions are only intended to record the implementations or embodiments of technical means used to resolve the problems in the present creation, but are not intended to limit the implementing scope of the of the present creation. That is, any equivalent changes and modifications consistent with the meaning within the application scope of the present creation or made according to the scope of the present creation shall fall within the scope of the present creation.

What is claimed is:

1. A method for calculating a service life of a filter gauze, wherein the filter gauze is applicable to an air cleaner, and the method comprises:
step S1: providing the filter gauze having a determined type, wherein there are a plurality of time periods from a time when the filter gauze starts to be used to a present time;
step S2: calculating a blocking ratio of the filter gauze in the time period by using a blocked area of the filter gauze in last time period;
step S3: calculating the blocked area of the filter gauze in the time period by using an airborne particle concentration, a rotational speed of a fan of the air cleaner and the blocking ratio of the filter gauze in the time period;
step S4: repeating step S2 and step S3, until the blocked area of the filter gauze in all time periods are calculated completely; and
step S5: calculating a remaining service life of the filter gauze by using the blocked area of the filter gauze in all time periods.

2. The method for calculating a service life of a filter gauze according to claim 1, wherein r(i) is a rotational speed of the fan of the air cleaner in the time period of i;
b(i) is a blocking ratio of the filter gauze in the time period of i;
c(i) is a particle concentration in the time period of i;
v(i) is the outlet air velocity in the time period of i;
t(i) is a continuous operating time in the time period of i;
v(i)=k1×r(i)×[1−b(i)] —formula 1, and
a(i)=k2×c(i)×v(i)×t(i) —formula 2, wherein
the blocked area of the filter gauze is:
a(i)=k1×k2×c(i)×r(i)×[1−b(i)]×t(i)=ka×c(i)×r(i)×[1−b(i)]×t(i) —formula 3,
wherein k1 is a ratio of the outlet air velocity to a rotational speed of a fan, k2 is a transform coefficient, and ka is a front constant ka=k1×k2.

3. The method for calculating a service life of a filter gauze according to claim 2, wherein the blocking ratio of the filter gauze is:
b(n)={a(1)+ . . . +a(n−1)}/A=Σᵢ₌₁ⁿ⁻¹a(i)/A, and b(1)=0, n≥2, wherein A is a total area of the filter gauze;
b(i)=Σⱼ₌₁ⁱ⁻¹a(j)/A, and b(1)=0,i≥2 —formula 4;
wherein all of the blocked areas a(i) in the time period of i (i=1 to n) are calculated completely by alternately using the formula 3 and formula 4.

4. The method for calculating a service life of a filter gauze according to claim 3, wherein another filter gauze having the same determined type is selected and is used in the laboratory, and when the another filter gauze is new and the rotational speed of the fan of the air cleaner is fixed to be R, the outlet air velocity is measured to be V1 and the ratio k1 is expressed as: k1=V1/R—formula 5.

5. The method for calculating a service life of a filter gauze according to claim 4, wherein when a value of a total amount of air that is filtered per hour (CADR) reduces from CADR-max to 0.5×CADR-max, and simultanously the outlet air velocity is measured to be V2, and
an average air velocity Vavg=(V1+V2)/2, wherein:
when the filter gauze to be measured is provided with an airborne particle concentration of C, an operation time required for the value of the total amount of the air that can be filtered per hour (CADR) by the air cleaner to reduce from CADR-max to 0.5×CADR-max is assumed to be a reference service life of the filter gauze, the reference service life being T.

6. The method for calculating a service life of a filter gauze according to claim 5, wherein:
the transform coefficient k2 is expressed as:
k2=A×/[C×T×(V1+V2)] —formula 6.

7. The method for calculating a service life of a filter gauze according to claim 6, wherein:
the front constant ka is expressed as:
$$ka = \frac{AV 1}{CRT ( V 1 + V 2 )} ; \qquad formula 7$$
the blocked area a(i) of the filter gauze at the time period of i is expressed as:
$$a ( i ) = \frac{AV 1}{CRT ( V 1 + V 2 )} \times c ( i ) \times r ( i ) \times [ 1 - b ( i ) ] \times t ( i ) , \qquad formula 8$$
wherein all of the blocked areas a(i) of the filter gauze in the time period of i (i=1 to n) are calculated completely by alternately using formula 8 and formula 4; and
the remaining service life tr of the filter gauze is:
tr={[A−Σᵢ₌₁ⁿa(i)]/Σᵢ₌₁ⁿa(i)}×t —formula 9,
wherein t is a sum of all the time periods t(i) (i.e., t=Σᵢ₌₁ⁿt(i)).
